(19) United States
(12) Patent Application Publication
(10) Pub. No.: US 2022/0334344 A1
(43) Pub. Date: Oct. 20, 2022

(54) WORM DRIVE FOCUS MECHANISM

(71) Applicant: Cubic Corporation, San Diego, CA (US)

(72) Inventors: Abram Summerfield, Orofino, ID (US); Brian Bellah, Orofino, ID (US)

(21) Appl. No.: 17/720,423

(22) Filed: Apr. 14, 2022

Related U.S. Application Data
(60) Provisional application No. 63/174,963, filed on Apr. 14, 2021.

(51) Int. Cl. G02B 7/02

(52) U.S. Cl. CPC G02B 7/022; G02B 7/021

(57) ABSTRACT

A worm drive focus mechanism may include a housing comprising an inner surface that defines a central conduit that extends through a distal end of the housing. The inner surface comprises a first threaded interface. A focus tube may be disposed within the central conduit. An outer surface of the focus tube may include a second threaded interface that is engaged with the first threaded interface. The outer surface may include gear teeth that protrude radially outward from the outer surface. A lens may be coupled with an end of the focus tube. A worm gear may be engaged with the gear teeth such that rotation of the worm gear causes a rotation of the focus tube within the central conduit that causes translation of the focus tube. A locking mechanism may be selectively engageable to prevent rotation and translation of the focus tube relative to the central conduit.

### CROSS-REFERENCE TO RELATED APPLICATIONS

This application claims the benefit of and is a non-provisional of co-pending U.S. Provisional Application Ser. No. 63/174,963 filed on Apr. 14, 2021, which is hereby expressly incorporated by reference in its entirety for all purposes.

### BACKGROUND OF THE INVENTION

Threaded focus tubes are common methods for holding lenses and translating the lenses axially. However, conventional tubes provide only gross motion where rotation of the focus tube is a direct input resulting in lens motion equal to the thread pitch of the threaded focus tube, per rotation of the focus tube. Traditional threaded lens tubes do not provide any reduction to sensitivity through gear reduction. User input via rotating the threaded focus tube results in a 1:1 input to the lens movement. For example, if a user rotates the lens 180 degrees, the linear motion of the lens is equal to 180/360×thread pitch. For a fine pitch thread such as, an M18×1 mm thread (i.e., thread pitch of 1 mm), this linear motion would be 0.5 mm. Conventional lens focusing systems may also have other problems. For example, cam-driven focus mechanisms are often used in riflescopes to position focus lenses. Cam-driven focus mechanisms use a machined cam profile inside a rotating dial that uses a series of bushings and drive rods/arms to position a lens element. Such mechanisms are able to provide input-to-output sensitivity reduction, but do not offer self-locking, or external locking abilities, can therefore be easily adjusted unintentionally, especially during transport or use. Such assemblies are also bulky and complex making them best suited for large optical devices. These mechanisms are quite large, and not suited for handheld size optical devices. Therefore, improvements in lens focusing mechanisms are desired.

### BRIEF SUMMARY OF THE INVENTION

Some embodiments of the present technology may encompass worm drive focus mechanisms. The focus mechanisms may include a housing having an inner surface that defines a central conduit that extends through a distal end of the housing. The inner surface may include a first threaded interface. The focus mechanisms may include a focus tube that is disposed within the central conduit. An outer surface of the focus tube may include a second threaded interface that is engaged with the first threaded interface of the housing. The outer surface may include gear teeth that protrude radially outward from the outer surface. The focus mechanisms may include a lens that is coupled with an end of the focus tube such that translation of the focus tube within the central conduit causes a corresponding translation of the lens. The focus mechanisms may include a worm gear that is engaged with the gear teeth such that rotation of the worm gear causes a rotation of the focus tube within the central conduit. The rotation may cause translation of the focus tube within the central conduit due to the engagement of the first threaded interface and the second threaded interface. The focus mechanisms may include a locking mechanism that is selectively engageable to permit rotation and translation of the focus tube relative to the central conduit in an unlocked configuration and to prevent rotation and translation of the focus tube relative to the central conduit in a locked configuration.

In some embodiments, the locking mechanism may include a locking arm that is deformable to clamp the first threaded interface against the second threaded interface to prevent relative rotation between the first threaded interface and the second threaded interface. The locking mechanism may include a threaded member that is engaged with the locking arm such that tightening of the threaded member deforms the locking arm to clamp the first threaded interface against the second threaded interface. The locking mechanism may include a snap ring that is engaged with the threaded member and a distal surface of the locking arm such that tightening of the threaded member pulls the snap ring toward the distal surface of the locking arm to deform the locking arm and clamp the first threaded interface against the second threaded interface. The locking arm may be aligned with the first threaded interface. The worm gear may include a head defining a drive recess that is configured to receive an end of a tool for rotating the worm gear. The drive recess may include a hex socket, a Phillips head socket, a flat head socket, or a star socket.

Some embodiments of the present technology may encompass worm drive focus mechanisms that may include a housing defining a central conduit. A wall of the central conduit may include a first threaded interface. The focus mechanisms may include a focus tube that is disposed within the central conduit. The focus tube may include a second threaded interface that is engaged with the first threaded interface of the housing. The focus tube may include gear teeth that protrude radially outward. The focus mechanisms may include a lens that is coupled with the focus tube. The focus mechanisms may include a worm gear that is engaged with the gear teeth such that rotation of the worm gear causes a rotation and translation of the focus tube within the central conduit. The focus mechanisms may include a locking mechanism that is selectively engageable to permit rotation and translation of the focus tube relative to the central conduit in an unlocked configuration and to prevent rotation and translation of the focus tube relative to the central conduit in a locked configuration.

In some embodiments, the gear teeth may include helical gear teeth. The worm gear may include a head having a circumferential surface with a roughened texture. The lens may be disposed within a keyway of the focus tube such that the focus tube rotates independently of the lens. A gear ratio between the worm drive and the gear teeth may be greater than or about 10:1. A pitch of the first threaded interface and the second threaded interface may be less than or about 2 mm. The lens may rotate at a same rate as the focus tube.

Some embodiments of the present technology may encompass worm drive focus mechanisms that may include a housing. The focus mechanisms may include a focus tube that is disposed within and is linearly translatable relative to the housing. The focus tube may include gear teeth. The focus mechanisms may include a lens coupled with the focus tube. The focus mechanisms may include a worm gear that is engaged with the gear teeth. Rotation of the worm gear may cause a linear translation of the focus tube and the lens within the housing. The focus mechanisms may include a locking mechanism that is selectively engageable to prevent translation of the focus tube.

In some embodiments, the focus tube may be translatable via relative rotation of engaged threads of the focus tube and the housing. The locking mechanism may include a screw that, when tightened, clamps the engaged threads together to prevent relative rotation of the engaged threads. A linear translation of the focus tube for a full rotation of the worm gear may be less than about 0.1 mm. In a fully extended position, the lens may extend beyond a distal end of the housing. The worm gear may include a single start worm gear, a double start worm gear, or a triple start worm gear.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a set of parentheses containing a second label that distinguishes among the similar components. If only the first reference label is used in the specification, the description is applicable to any one of the similar components having the same first reference label irrespective of the second reference label.

FIG. 1 illustrates an isometric view of a focus tube of a focus mechanism according to embodiments of the present invention.

FIG. 2A illustrates a partial isometric view of a focus mechanism according to embodiments of the present invention.

FIG. 2B illustrates a sectional bottom plan view of the focus mechanism of FIG. 2A.

FIG. 2C illustrates a sectional bottom perspective view of the focus mechanism of FIG. 2A.

FIG. 2D illustrates a sectional front elevation view of the focus mechanism of FIG. 2A.

FIG. 2E illustrates a partial sectional side perspective view of the focus mechanism of FIG. 2A.

FIG. 2F illustrates a sectional back elevation view of the focus mechanism of FIG. 2A.

FIG. 3A illustrates an isometric view of a scope assembly according to embodiments of the present invention.

FIG. 3B illustrates a partial isometric view of the scope assembly of FIG. 3A.

FIG. 3C illustrates a sectional side elevation view of the scope assembly of FIG. 3A.

FIG. 3D illustrates a partial sectional side elevation view of the scope assembly of FIG. 3A.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to focus mechanisms that provide improved precision in lens positioning (i.e., focusing). In imaging optics, precise lens spacing is required to create a well-functioning system. Focus lenses are movable lens elements that can be shifted along the optical axis to correct for external factors such as distance to target and thermal effects. In high quality imaging optics, the position of this lens is very sensitive, and must be positioned in the micron scale to function properly. The worm drive focus mechanisms described herein provide very fine adjustment resolution and the ability to secure a lens in position once the desired focus is achieved. For example, the gear ratio may be selected such that a user input of 10 degrees rotation to the worm gear may provide only a few microns of translation of the lens (i.e., change in focal position). This greatly reduces system sensitivity and is well suited for high quality optical devices. The use of a worm gear also provides perpendicular input to motion direction. For compact optical devices, this change of input direction to output direction is necessary. The focus mechanisms described herein can be very compact and is also robust making it well suited for hostile environments such as weapon recoil experience by riflescopes and accessories.

Embodiments of the present invention may be utilized to focus a lens for any type of adjustable optical system. Embodiments of the present invention may enable users to make coarse physical adjustments to an input device that result in very fine adjustments to the lens position, thereby enhancing the user experience by providing a focus mechanism that is more easily adjusted. Embodiments may achieve better lens positioning precision by incorporating a worm gear drive that may increase the gear ratio, which may enable larger physical manipulations by a user to generate very fine changes in lens positioning. Additionally, embodiments of the present invention may incorporate locking mechanisms that may enable a desired lens position to be fixed. This may enable the focus mechanism to avoid unintended lens motion and any resulting focus shift when impacted by outside forces, such as weapon shock associated with gunfire. Embodiments of the present invention may be retrofitted to work in conjunction with existing optical devices (such as rifle scopes), beam splitters, image devices, etc. and/or integrated directly into the structure of an optical device.

While discussed primarily with respect to rifle scopes, it will be appreciated that the beam splitters may be used in other optical systems, such as, but not limited to, other afocal optical systems. For example, the focus mechanisms described herein may be utilized within laser optics, (e.g., as beam expanders), Infrared systems, forward looking infrared systems, camera zoom lenses, and telescopic lens attachments (e.g., teleside converters), binoculars, photography setups combining cameras and telescopes, and/or other optical systems.

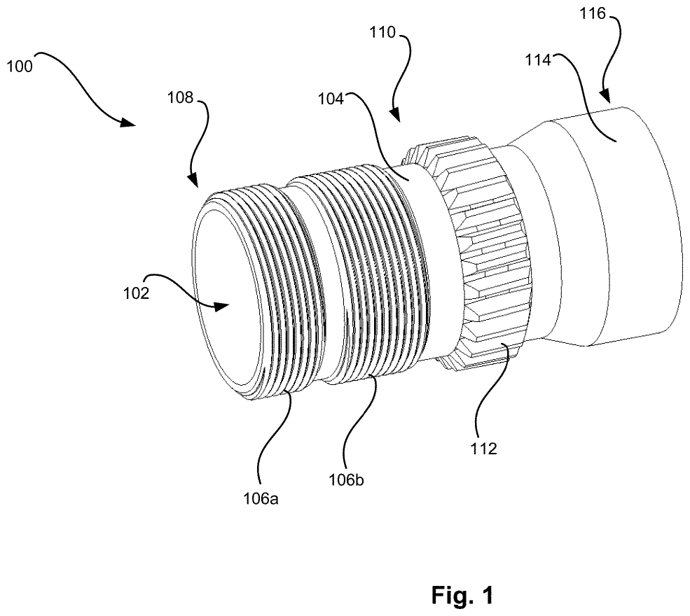

Turning now to FIG. 1, one embodiment of a focus tube 100 is illustrated. Focus tube 100 may be generally cylindrical (e.g., may have a circular cross-section) and may define an open interior 102. An outer surface 104 of the focus tube 100 may define or include one or more threaded interfaces 106. For example, two threaded interfaces 106 may be spaced apart from one another long a length of the focus tube 100, with a first of the threaded interfaces 106a being disposed proximate a proximal end 108 of the focus tube 100, while a second of the threaded interfaces 106b may be disposed in a medial region 110 of the focus tube 100. Each threaded interface 106 may have a thread pitch of less than or about 2 mm, less than or about 1.75 mm, less than or about 1.5 mm, less than or about 1.25 mm, less than or about 1 mm, less than or about 0.75 mm, less than or about 0.5 mm, or less.

The outer surface 104 may also define or include a number of gear teeth 112 that may protrude radially outward from the outer surface 104. The gear teeth 112 may extend entirely about a circumference of the outer surface 104. In some embodiments, gear teeth 112 may be disposed within the medial region 110, such as on an opposite side of the threaded interface 106b as threaded interface 106a. In some embodiments, the gear teeth 112 may be spur gear teeth (i.e., a longitudinal axis of each tooth is aligned along a longitudinal axis of the focus tube 100), while in other embodiments the gear teeth 112 may be helical gear teeth (i.e., a longitudinal axis of each tooth is angled relative to the longitudinal axis of the focus tube 100). The use of helical gear teeth 112 may provide a smoother gear performance as compared to the use of spur gear teeth. The gear teeth 112 may be provided at regular intervals about the circumference of the outer surface 104. Any number of gear teeth 112 may be included, with greater numbers of gear teeth resulting in a higher gear ratio. For example, the focal tube 100 may include at least or about 10 gear teeth, at least or about 12 gear teeth, at least or about 14 gear teeth, at least or about 16 gear teeth, at least or about 18 gear teeth, at least or about 20 gear teeth, at least or about 22 gear teeth, at least or about 24 gear teeth, at least or about 26 gear teeth, at least or about 28 gear teeth, at least or about 30 gear teeth, or more.

In some embodiments, the focal tube 100 may include a lens mounting 114 that may be useable to secure a lens (not shown) at or proximate a distal end 116 of the focal tube 100. For example, as illustrated, the lens mounting 114 may be or include a collar having an expanded diameter relative to the rest of the focal tube 100 and that may accommodate a lens that is received within the collar. In some embodiments, the lens may be press fit and/or adhered to an inner surface of the collar such that any rotation of the focal tube 100 causes a corresponding rotation (at a same rate) of the lens. In other embodiments, an inner surface of the collar may include a keyway that enables the focus tube 100 to rotate independently of the lens. In particular, the use of the keyway may enable the lens to remain in a constant angular position at all times (e.g., not rotating), including during rotation of the focus tube 100. In some embodiments, rather than receiving the lens within a collar, a lens may be affixed to the distal end 116 of the focus tube 100, such as via an adhesive, mechanical coupler, and/or other securement technique. It will be appreciated that other techniques for mounting and/or otherwise affixing a lens to focus tube 100 may be utilized in various embodiments.

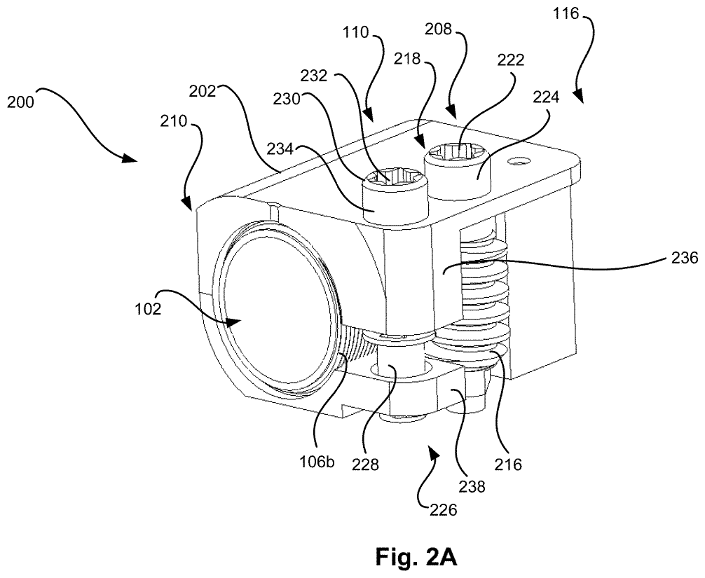

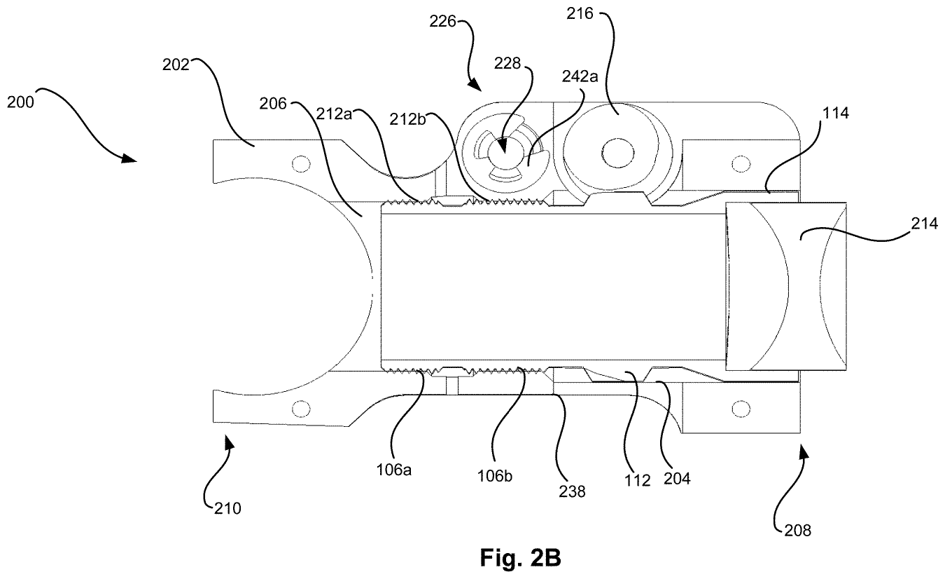

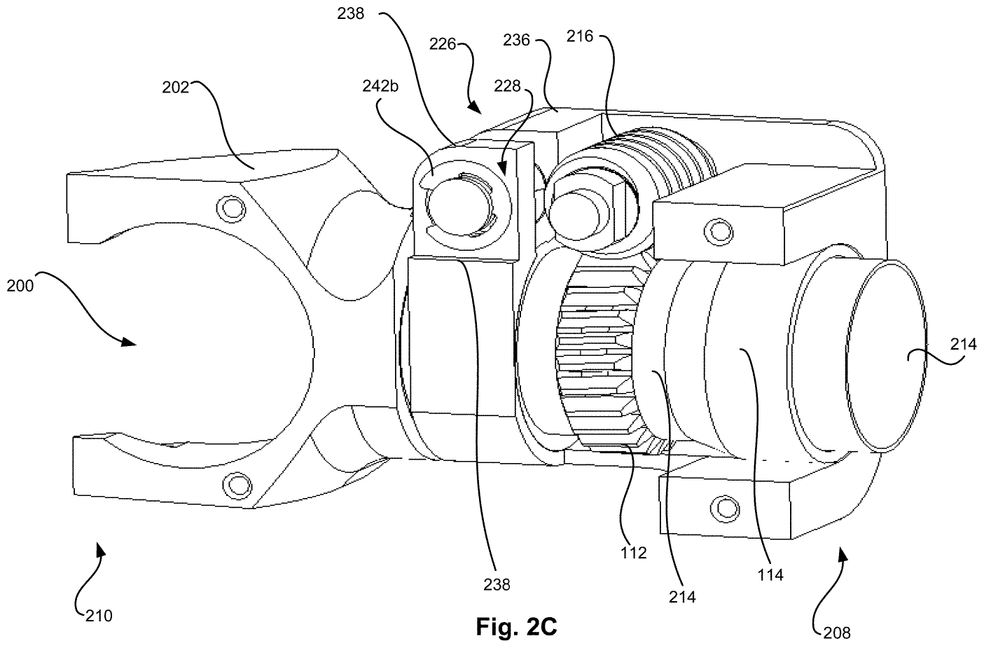

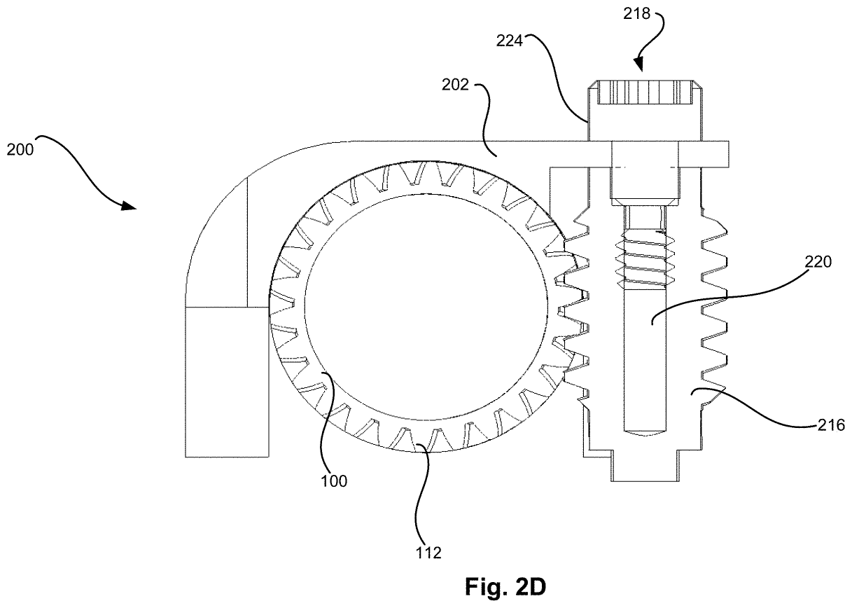

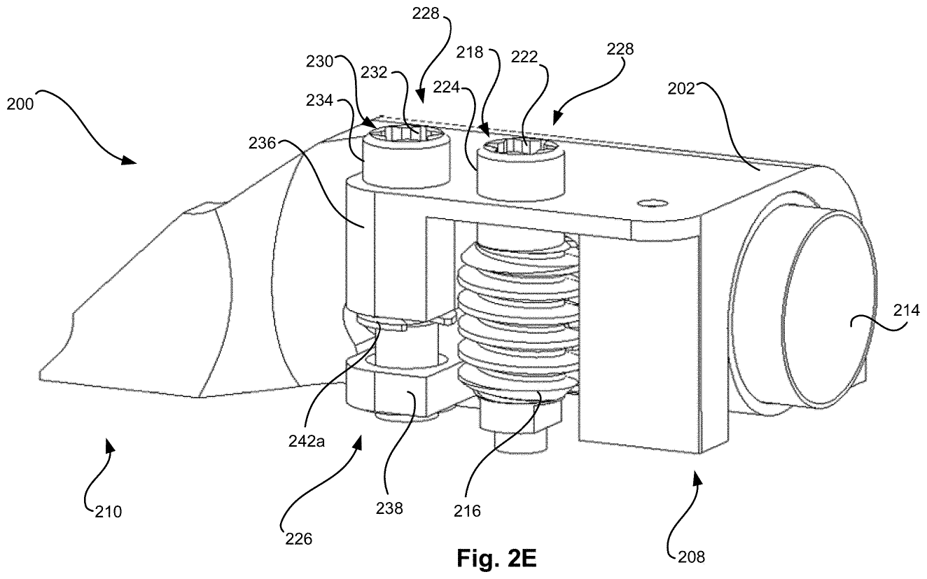

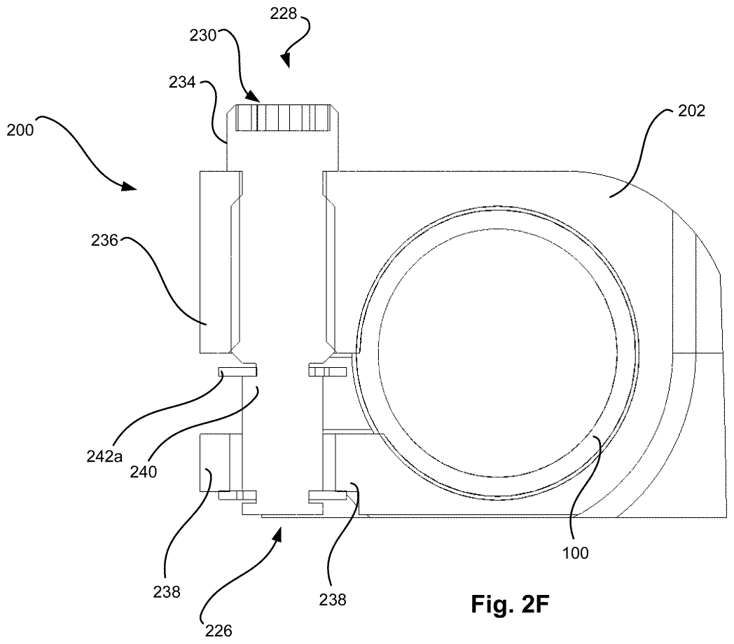

FIGS. 2A-2F illustrate a worm drive focus mechanism 200 according to embodiments of the present invention. As shown in FIG. 2A, the focus mechanism 200 may include a housing 202 that may house internal components and/or adjustment mechanisms of the focus mechanism 200. In some embodiments, the focus mechanism 200 may be mounted to an additional optical device as part of a larger optical system, while in other embodiments, the housing 202 may house components that form a standalone optic device. As best illustrated in FIG. 2B, the housing 202 may include an inner surface 204 that may define a central conduit 206 that extends through a distal end 208 of the housing 202 and may extend through at least a portion of the length of the housing 202 (e.g., the central conduit 206 may extend through an entirety of the housing through a proximal end 210 or may terminate within an interior of the housing 202). The central conduit 206 may be generally cylindrical in shape and may have a diameter that closely matches a diameter of the focal tube 100. The inner surface 204 of the housing 202 may define or include one or more threaded interfaces 212, which may correspond to the threaded interfaces 106 of the focal tube 100. For example, each threaded interface 212 may be sized and positioned in a similar manner as the threaded interfaces 106. As illustrated, two threaded interfaces 212 may be spaced apart from one another long a length of the housing 202, with a first of the threaded interfaces 212a being disposed proximate the proximal end 210 of the central conduit 206, while a second of the threaded interfaces 212b may be disposed in a medial region 250 of the housing 202/central conduit 206. Each threaded interface 212 may have a thread pitch that is equal to the thread pitch of the threaded interfaces 106 of the focus tube 100.

The focus tube 100 may be disposed within the central conduit 206. For example, the focus tube 100 may be inserted within the central conduit 206 from the distal end 208, and may be rotated to engage each threaded interface 106 with a corresponding threaded interface 212 of the housing 202. The focus tube 100 may be linearly translatable within the central conduit 206 by rotating the focus tube 100 relative to the housing 202 (e.g., the (and threaded interfaces 106 and threaded interfaces 212 rotate relative to one another).

A lens 214 may be coupled with the focus tube 100, which may enable the position of the lens 214 along a longitudinal axis of the focus mechanism 200 to be adjusted by rotating and translating the focus tube 100 relative to the housing 202. For example, as illustrated, the lens mounting 114 may be or include a collar having an expanded diameter relative to the rest of the focal tube 100, with the lens 214 being received in an interior of the collar. In some embodiments, the lens 214 may be fully inserted within the collar such that the lens 214 is flush with, or recessed relative to the distal end 116 of the focus tube 100. In other embodiments, such as illustrated, the lens 214 may be partially inserted within the collar such that a portion of the lens 214 extends beyond the distal end 116 of the focus tube 100. In some embodiments, to accommodate a larger collar of the focus tube 100, the central conduit 206 may have a larger diameter within a distal region of the focus tube 100. As noted above, the lens 214 may be press fit and/or adhered to an inner surface of the collar such that any rotation of the focal tube 100 causes a corresponding rotation (at a same rate) of the lens 214. In other embodiments, an inner surface of the collar may include a keyway that enables the focus tube 100 to rotate independently of the lens 214. Other techniques for mounting and/or otherwise affixing the lens 214 to focus tube 100 may be utilized in various embodiments.

As best illustrated in FIGS. 2C and 2D, a worm gear 216 may be disposed within the housing 202. The worm gear 216 may include one or more threads or starts. For example, the worm gear 216 may be a single start worm gear, a double start worm gear, or a triple start worm gear. The threads of the worm gear 216 may be engaged with the gear teeth 112 of the focus tube 100. This engagement may enable a user to adjust a focal position (i.e., position along the longitudinal axis of the central conduit 206) of the lens 214 by rotating the worm gear 216, as the threads of the worm gear 216 press against the gear teeth 112 to rotate the focus tube 100 within the central conduit 206. As the focus tube 100 rotates, the engaged threads 106, 212 of the focus tube 100 and the housing 202 rotate relative to one another, which causes the focus tube 100 to linearly translate along a longitudinal axis of the central conduit 206 to adjust the focal position of the lens 214. In some embodiments, in a fully extended position, the lens 214 may extend beyond the distal end 208 of the housing 202.

The number of gear teeth 112 of the focus tube 100 and starts/threads of the worm gear 216 may be selected to create a gear ratio that may provide a gear reduction that is beneficial in achieving very fine lens positioning. For example, the gear ratio may be selected such that a user input of 10 degrees rotation to the worm gear 216 may provide only a few microns of translation of the lens 214 (i.e., change in focal position). For example, the gear ratio of the worm gear 216 and gear teeth 112 may be greater than or about 10:1, greater than or about 15:1 greater than or about 20:1 greater than or about 25:1 greater than or about 30:1 greater than or about 35:1 greater than or about 40:1, or more. As noted above, a pitch of the threaded interfaces 106, 212 may be less than or about 2 mm, less than or about 1.75 mm, less than or about 1.5 mm, less than or about 1.25 mm, less than or about 1 mm, less than or about 0.75 mm, less than or about 0.5 mm, or less. The combination of the gear ratio and pitch may result in a linear translation of the focus tube 100 and lens 214 (for a full rotation of the worm gear 216) being less than about 0.1 mm, less than or about 0.05 mm, less than or about 0.01 mm, less than or about 0.005 mm, less than or about 0.001 mm, or less, which may enable the user to make coarse physical adjustments to the worm gear 216 with resulting adjustments of the focal position of the lens 214 being as small as the micron level.

As best illustrated in FIG. 2D, the worm gear 216 may include a head 218 that is positioned exteriorly of the housing 202. For example, the worm gear 216 may include a shaft 220 that extends though an aperture formed in the housing 202 and that receives a threaded portion of the worm gear 216. The shaft 220 may be threadingly engaged and/or otherwise secured within a threaded receptacle formed within the threaded portion of the worm gear 216 and may be coupled with the head 218. In a particular embodiment, the head 218 and shaft 220 may be in the form of a screw or bolt that is coupleable with the threaded portion of the worm gear 216. As best illustrated in FIGS. 2A and 2E, the head 218 of the worm gear 216 may define a drive recess 222 that is configured to receive an end of a tool for rotating the worm gear 216. For example, the drive recess 222 may enable a tool, such as a screwdriver, Allen key, and/or other device to be inserted within the drive recess 222 to enable the user to selectively rotate the worm gear 216, and subsequently tune the focal position of the lens 214. The drive recess 222 may include a hex socket, a Phillips head socket, a flat head socket, a star socket, and/or other socket designed to receive an end of a tool. In some embodiments, by providing a head 218 that requires a tool to turn, the worm gear 216 may be further prevented from being unintentionally rotated. In other embodiments, in addition to or instead of the drive recess 222, head 218 may include a circumferential surface 224 that may include a roughened texture to enable a user to rotate the worm gear 216 by hand and/or using a gripping device, such as pliers or a clamp. The texture may include knurling, grooves, milling, and/or other texture that may enhance the ability to grip the circumferential surface 224.

To ensure that the focal position of the lens 214 of the focus mechanism 200 does not inadvertently change after the focal position has been set by user, the focus mechanism 200 may include a locking mechanism 226 that, when engaged, may prevent any translation of the focus tube 100 and lens 214 relative to the central conduit 206. For example, when in an unlocked configuration, the locking mechanism 226 may permit rotation and translation of the focus tube 100 relative to the central conduit 206 in an unlocked configuration, and when in the locked position may prevent rotation and translation of the focus tube 100 relative to the central conduit 206.

As best illustrated in FIGS. 2D and 2E, the locking mechanism 226 may include a screw 228 (or other threaded fastener) that extends through a portion of the housing 202. For example, the screw 228 may include a head 230, which may be similar to the head 218 of the worm gear 216. For example, the head 230 may define a drive recess 232 and/or may have a circumferential surface 234 that may include a roughened texture to enable a user to rotate the screw 228 by hand. In some embodiments, the head 218 and head 230 may have an identical design, which may enable the heads 218, 230 to be rotated in a same manner, while in some embodiments, the heads 218, 230 may have different designs. In some embodiments, a height and/or diameter of the heads 218, 230 may be the same, while in other embodiments, the height and/or diameter of the heads 218, 230, which may enable a user to readily discern which head is associated with the worm gear 216 and which head is associated with the locking mechanism 226.

As illustrated, a portion of the housing 202 may include a main body 236 and a locking arm 238 that is spaced apart from the main body 236 by a gap. The locking arm 238 may be generally aligned with the screw 228 and at least one of the threaded interfaces 212. For example, the locking arm 238 may extend laterally outward from a portion of the housing 202 that includes threaded interface 212b. A shaft 240 of the screw 228 may extend through both the main body 236 and the locking arm 238, with the head 230 remaining external to the housing 202. The shaft 240 of the screw 228 may be engaged with the locking arm 238 such that tightening of the screw 228 draws and/or otherwise deforms the locking arm 238 toward the main body 236 to reduce the size of the gap and clamp the engaged threads of threaded interface 106b and 212b together to create an interference fit that prevents relative rotation of the engaged threads (and therefore the rotation and/or translation of the focus tube 100 and lens 214 relative to the central conduit 206). Loosening the screw 228 may enable the locking arm 238 to return to a default position, which unclamps the threads and enables the focus tube 100 and lens 214 to be rotated and/or translated within the central conduit 206 upon rotation of the worm gear 216.

In a particular embodiment, a number of snap rings 242 may be interfaced with the shaft 240 of the screw 228 to aid in the clamping of the locking arm 238 and main body 236. For example, each snap ring 242 may be disposed within a respective groove formed within the shaft 240 of the screw 228. As illustrated, a snap ring 242a may be disposed on the shaft 240 within the gap between the main body 236 and locking arm 238, with the snap ring 242a being positioned proximate an inner surface of the main body 236. A snap ring 242b may be positioned proximate an exterior surface of the locking arm 238. As the screw 228 is tightened, the snap ring 242b may be drawn against the exterior surface of the locking arm 238, which may cause the snap ring 242b to force the locking arm 238 to deform and move toward the main body 236 to lock the focal position of the lens 214. As the screw 228 is loosened, the snap ring 242b may be moved in a direction opposite the locking arm 238 to enable the locking arm 238 to move away from the main body 236 until a default position of the locking arm 238 is reached. This movement reduces, and eventually eliminates, any clamping force generated by the locking arm 238 and will permit relative rotation between the focus tube 100 and central conduit 206.

The locking mechanism 226 provides added security, ensuring that under the harshest conditions the lens 214 is held rigid at a desired position relative to the central conduit 206. The locking mechanism 226 not only prevents linear translation of the lens 214, but also removes any thread slop and/or any potential decenter or tilt of the lens 214. Paired with the worm gear 216, users can “lock” and “unlock” the focus tube 100 and lens 214 without experiencing focus shift. This redundant security feature is very advantageous as it prevents unwanted focus shift during use.

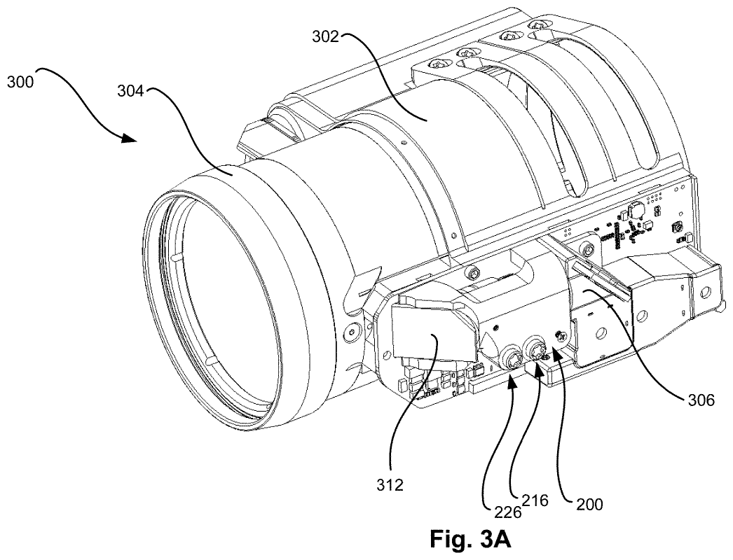

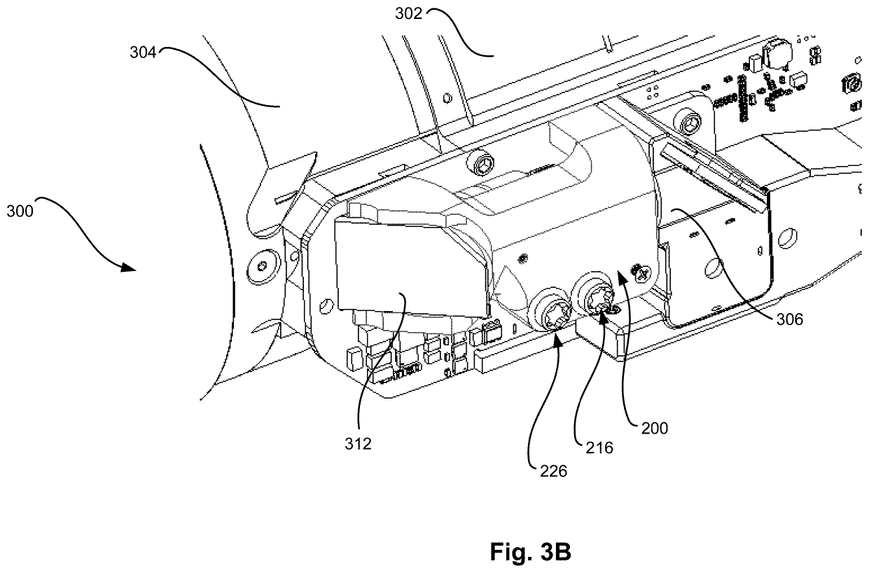

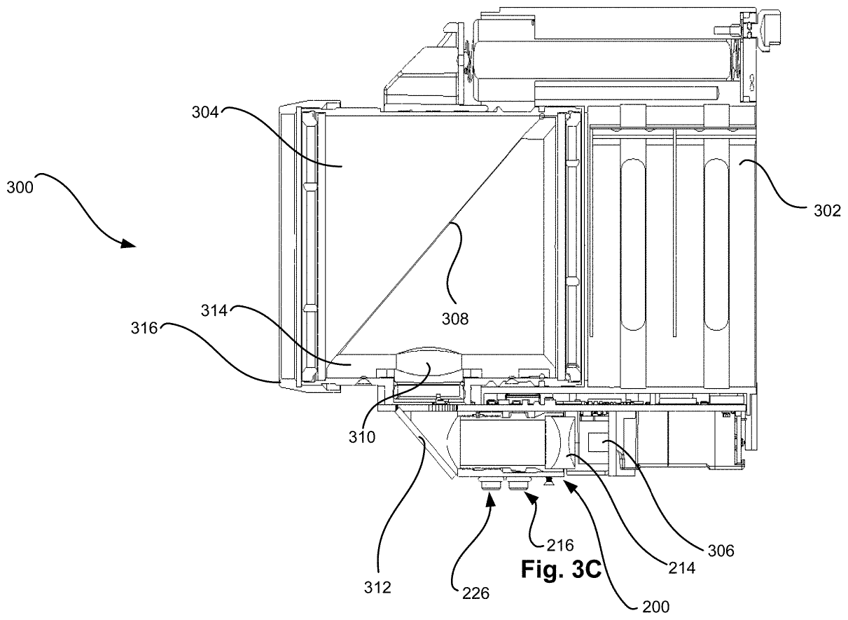

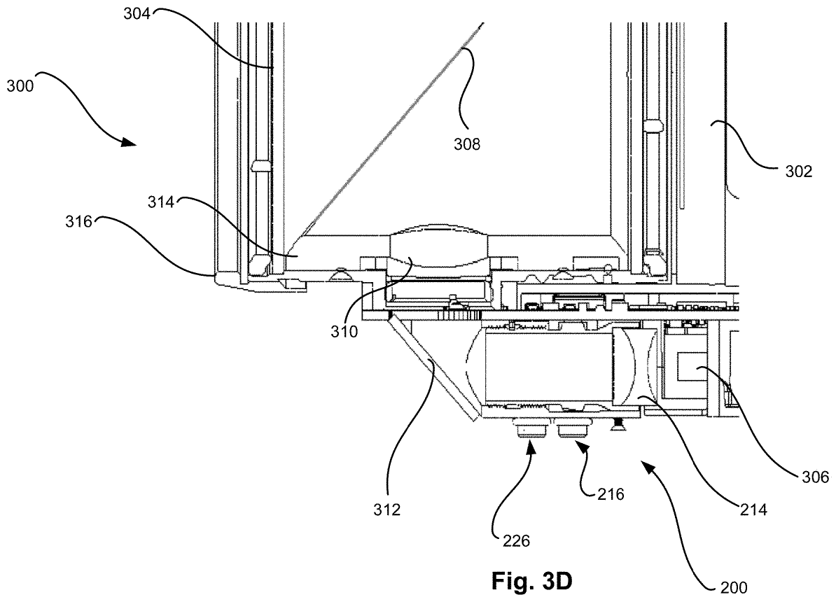

In some embodiments, the focus mechanism 200 may be incorporated into a larger optical assembly. As just one example, the focus mechanism 200 may be used as part of a smart scope assembly, which may provide an overlay of data in a field of view through the host optic. The data may include, for example, but not limited to, reticles, the ballistically corrected aiming coordinates based on target range, gun/bullet type, atmospheric conditions, and/or other information. FIGS. 3A-3D illustrate one embodiment of a smart scope 300 that incorporates focus mechanism 200. Smart scope 300 may include a scope 302, such as a rifle scope, that may be optically coupled (or may include) a beam splitter 304. For example, an optical axis of the scope 302 may be coaxial with an optical axis of the beam splitter 304. Disposed beneath the beam splitter 304 and/or scope 302 may be an image device 306 that may be optically coupled with a reflective surface 308 of the beam splitter 304. Image device 306 may include one or more image capture devices, such as cameras, and/or one or more image generator devices, such as projectors. As illustrated, the image device 306 may enable information to be projected and/or otherwise overlaid over a portion of the field of view of the scope 302, such as by projecting the image onto the beam splitter 304. In other embodiments, the beam splitter 304 may be used to transmit data from the field of view of the scope 302 to an image capture device. For example, the orientation of the beam splitter 304 may be reversed such that the reflective surface 308 slopes downward from front to back. The reflective surface 308 may then reflect a portion of the image viewed through the scope 302 and beam splitter 304 into the image capture device. In some embodiments, an optical axis of the image device 306 may be aligned with the optical axis of a lens 310 of the beam splitter 304 and a second optical axis (that is orthogonal to the longitudinal axis of the scope 302 and coaxial with the optical axis of the lens 310) of the reflective surface 308. However, as illustrated, the image device 306 is disposed in a manner such that the optical axis of the image device 306 is orthogonal to the optical axis of the lens 310 and the second optical axis of the reflective surface 308. In such configurations, a reflector 312, such as a mirror, may be positioned (such as at a 45 degree angle relative to the orthogonal axes) and used to optically couple the optical axis of the image device 306 with the optical axis of the lens 310 and the second optical axis of the reflective surface 308. It will be appreciated that numerous other configurations of the various optical axes may be utilized, with any number (including zero) of reflectors being used to optically couple the various components. The focus mechanism 200 may be incorporated into the image device 306 and/or may be disposed between the image device 306 and the reflector 312, which may enable adjustments of the lens 214 of the focus mechanism 200 to help focus optical data being exchanged between the beam splitter 304 and image device 306.

While shown with the beam splitter 304 positioned in front of the scope 302, it will be appreciated that the beam splitter 304 may be positioned rearward of the scope 302 in some embodiments, and may be integrated into the scope 302 in some embodiments. For example, the beam splitter 304 may be positioned between front and rear lenses of the scope or other optic.

In some embodiments, the reflecting surface 308 of the beam splitter 304 may be in the form of a pellicle, which may have a flatness of within about 0.5 waves (λ/2) or better for a 25× magnification riflescope. The pellicle may have a thickness of less than about 100 microns. For example, the thickness may be between or about 2 microns and 100 microns, between or about 2 microns and 90 microns, between or about 2 microns and 80 microns, between or about 2 microns and 70 microns, between or about 2 microns and 60 microns, between or about 2 microns and 50 microns, between or about 2 microns and 40 microns, between or about 2 microns and 30 microns, between or about 2 microns and 25 microns, between or about 2 microns and 20 microns, or between or about 10 microns and 20 microns. By making the pellicle sufficiently flat and sufficiently thin, wavefront deformation of the pellicle may be substantially or entirely eliminated, which may result in better image quality/resolution through the primary optic.

The pellicle may be mounted on a pellicle frame 314 that is disposed within a housing 316 of the beam splitter 304. The pellicle frame 314 may include a spine that extends outward from an outer surface of the pellicle frame and that is used to secure the pellicle frame 314 with an inner surface of the housing, while a substantial portion of the pellicle frame 314 is separated from the inner surface of the housing by an air gap. For example, the spine may include less than or about 20% of the entire outer surface, less than or about 15%, less than or about 10%, less than or about 5%, or less. In embodiments in which a cross-section of the outer surface is generally circular, the spine may extend along less than or about 72 degrees of the cross-section, less than or about 54 degrees, less than or about 36 degrees, less than or about 18 degrees, less than or about 9 degrees, or less.

The air gap may enable the pellicle frame 314 (and pellicle) to be substantially floating relative to the housing 316. By substantially floating the pellicle frame 314 and pellicle, the beam splitter 304 may enable thermal expansion of the various components without risk of deformation of the pellicle. Additionally, when mounted on a scope, the substantially floating nature of the pellicle and pellicle frame 314 may help prevent the pellicle from being impacted (e.g., being distorted, deformed, and/or otherwise damaged) by outside forces, such as physical hoop stresses that may apply a crushing force to the housing 316.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

While illustrative and presently preferred embodiments of the disclosed systems and devices have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein. As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A worm drive focus mechanism, comprising:
a housing comprising an inner surface that defines a central conduit that extends through a distal end of the housing, wherein the inner surface comprises a first threaded interface;
a focus tube that is disposed within the central conduit, wherein:
an outer surface of the focus tube comprises a second threaded interface that is engaged with the first threaded interface of the housing; and
the outer surface comprises gear teeth that protrude radially outward from the outer surface;
a lens that is coupled with an end of the focus tube such that translation of the focus tube within the central conduit causes a corresponding translation of the lens;
a worm gear that is engaged with the gear teeth such that rotation of the worm gear causes a rotation of the focus tube within the central conduit, wherein the rotation causes translation of the focus tube within the central conduit due to the engagement of the first threaded interface and the second threaded interface; and
a locking mechanism that is selectively engageable to permit rotation and translation of the focus tube relative to the central conduit in an unlocked configuration and to prevent rotation and translation of the focus tube relative to the central conduit in a locked configuration.

2. The worm drive focus mechanism of claim 1, wherein:
the locking mechanism comprises a locking arm that is deformable to clamp the first threaded interface against the second threaded interface to prevent relative rotation between the first threaded interface and the second threaded interface.

3. The worm drive focus mechanism of claim 2, wherein:
the locking mechanism further comprises a threaded member that is engaged with the locking arm such that tightening of the threaded member deforms the locking arm to clamp the first threaded interface against the second threaded interface.

4. The worm drive focus mechanism of claim 3, wherein:
the locking mechanism comprises a snap ring that is engaged with the threaded member and a distal surface of the locking arm such that tightening of the threaded member pulls the snap ring toward the distal surface of the locking arm to deform the locking arm and clamp the first threaded interface against the second threaded interface.

5. The worm drive focus mechanism of claim 2, wherein:
the locking arm is aligned with the first threaded interface.

6. The worm drive focus mechanism of claim 1, wherein:
the worm gear comprises a head defining a drive recess that is configured to receive an end of a tool for rotating the worm gear.

7. The worm drive focus mechanism of claim 6, wherein:
the drive recess comprises a hex socket, a Phillips head socket, a flat head socket, or a star socket.

8. A worm drive focus mechanism, comprising:
a housing defining a central conduit, wherein a wall of the central conduit comprises a first threaded interface;
a focus tube that is disposed within the central conduit, wherein:
the focus tube comprises a second threaded interface that is engaged with the first threaded interface of the housing; and
the focus tube comprises gear teeth that protrude radially outward;
a lens that is coupled with the focus tube;
a worm gear that is engaged with the gear teeth such that rotation of the worm gear causes a rotation and translation of the focus tube within the central conduit; and
a locking mechanism that is selectively engageable to permit rotation and translation of the focus tube relative to the central conduit in an unlocked configuration and to prevent rotation and translation of the focus tube relative to the central conduit in a locked configuration.

9. The worm drive focus mechanism of claim 8, wherein:
the gear teeth comprise helical gear teeth.

10. The worm drive focus mechanism of claim 8, wherein:
the worm gear comprises a head having a circumferential surface with a roughened texture.

11. The worm drive focus mechanism of claim 8, wherein:
the lens is disposed within a keyway of the focus tube such that the focus tube rotates independently of the lens.

12. The worm drive focus mechanism of claim 8, wherein:
a gear ratio between the worm drive and the gear teeth is greater than or about 10:1.

13. The worm drive focus mechanism of claim 8, wherein:
a pitch of the first threaded interface and the second threaded interface is less than or about 2 mm.

14. The worm drive focus mechanism of claim 8, wherein:
the lens rotates at a same rate as the focus tube.

15. A worm drive focus mechanism, comprising:
a housing;
a focus tube that is disposed within and is linearly translatable relative to the housing, the focus tube comprising gear teeth;
a lens coupled with the focus tube; and
a worm gear that is engaged with the gear teeth, wherein rotation of the worm gear causes a linear translation of the focus tube and the lens within the housing.

16. The worm drive focus mechanism of claim 15, wherein:
the focus tube is translatable via relative rotation of engaged threads of the focus tube and the housing.

17. The worm drive focus mechanism of claim 15, further comprising:
a locking mechanism that is selectively engageable to prevent translation of the focus tube.

18. The worm drive focus mechanism of claim 17, wherein:
the locking mechanism comprises a screw that, when tightened, clamps the engaged threads together to prevent relative rotation of the engaged threads.

19. The worm drive focus mechanism of claim 15, wherein:
a linear translation of the focus tube for a full rotation of the worm gear is less than about 0.1 mm.

20. The worm drive focus mechanism of claim 15, wherein:
in a fully extended position, the lens extends beyond a distal end of the housing.
